(19) United States
(12) Patent Application Publication
(10) Pub. No.: US 2021/0227794 A1
(43) Pub. Date: Jul. 29, 2021

(54) PET WALKING ORGANISATIONAL DEVICE

(71) Applicant: Matthew Benoche, Calgary (CA)

(72) Inventor: Matthew Benoche, Calgary (CA)

(21) Appl. No.: 17/159,365

(22) Filed: Jan. 27, 2021

Related U.S. Application Data
(60) Provisional application No. 62/966,889, filed on Jan. 28, 2020.

(51) Int. Cl. A01K 27/00; B65F 1/14

(52) U.S. Cl. CPC A01K 27/008; A01K 27/003; B65F 2240/136; B65F 1/1426

(57) ABSTRACT

A pet waste bag storage system for mounting on animal leashes. A securement means for detachable rigid securement to an existing extendable or permanent length pet leash. A clip mechanism attached to the outer surface of the device for securing of the waste bag end. A clip mechanism for semi-permanent securing of the soiled pet waste bags.

### CROSS-REFERENCE TO RELATED APPLICATIONS

The present application claims priority to U.S. provisional patent application Ser. No. 62/966,889 filed on Jan. 28, 2020. The entire disclosure is included herein in its entirety at least by reference.

### BACKGROUND OF THE INVENTION

### 1. Field of the Invention

The invention relates to storage and dispensing of unused pet waste bags along with temporary storage of soiled waste bags. In particular, the invention relates to a pet waste bag storage device that is used in combination with a variety of leash styles to add a rigidly mounted and compact method to store waste bag rolls, easily dispense the individual waste bags and store soiled waste bags.

### 2. Description of Related Art

North Americans have approximately 100 million dogs as domesticated pets, the majority of who are walked daily. Most regions and municipalities have laws requiring owners to pick up any feces left by their pets, as well as laws requiring their pets to be on leash. These laws create a need for a convenient way to store and transport both unused waste bags and the waste bags after the feces is collected.

Previous attempts at creating a waste bag dispensing device involved using both hands to remove the single waste bag from the roll, these devices create an issue because to tear off the bag from the roll it needs to be over unrolled to allow both sides of the perforations of the bag roll to be gripped to tear apart, this makes for the roll end to hang away from the device as well as requiring two hands to perform the tear. Many of these devices either hang down from the leash moving freely making it awkward to try to grip and dispense a bag while controlling one or more dogs or require the purchasing of a custom retractable leash.

Previous attempts at storage devices for soiled waste bags are devices with internal compartments to store the soiled waste bag. This creates extra bulk and is overkill for the temporary storage of soiled waste bags. Other devices create either an over complicated latching system or are devices meant to hang down by chain or rubber strap, both of which require two hands to insert and remove the used waste bag which will make the device awkward to operate while trying to control one or more animals.

Therefore, what is clearly needed is an organizational device that solves the problems mentioned above.

### BRIEF SUMMARY OF THE INVENTION

In one embodiment of the present invention a pet waste bag storage system is provided comprising a cylindrical housing formed with an interior compartment including a bag roll containment chamber, a securement means for detachable rigid securement to an existing extendable or permanent length pet leash, a clip mechanism attached to the outer surface of the device, said clip is configured to create a passageway for means of securing of the waste bag end. A clip mechanism for semi-permanent securing of the pet waste bag disposed to the outer surface of the said cylindrical body and runs parallel to said body directed along the circumference of said cylindrical body, the open end of the said clip creating a wedge for semi-permanent securing of a knotted bag. Also, in one embodiment the clamp assembly contains screws of increased length to correspond with an increased height to the corresponding receptacle pillars on the body allowing for attachment to a variety of thickness of leashes. Also in one embodiment the clip mechanism for securing the end of a waste bag contains an inlet to said passageway, the said inlet has a larger diameter then the exit creating a constriction of the passageway to assist in securement of the waste bag end, the exit of the passageway of the said clip contains an edge which combined with the added resistance of the constricted passageway allows for the tearing of a perforated separator of a standard roll of disposable bags. Also in one embodiment the cylindrical body contains a tubular compartment for dispensing waste bags, said compartment is aligned along the longitudinal axis of the pet leash and an open end directed towards the user. Also, in one embodiment the said first tubular compartment contains an open-ended slot along the longitudinal axis of the said tubular whereas the said slot is open at the top of the said tubular. The said slot is open when the lid is removed and is closed with the lid reinstalled.

### BRIEF DESCRIPTION OF THE SEVERAL VIEWS OF THE DRAWINGS

FIG. 1 Is an illustrative view of the preferred embodiment of the invention in use. Shown is the user walking there dog with a retractable leash and the invention attached underneath.

FIG. 2 Is an enlarged view of the invention in FIG. 1 as it is attached to the retractable leash.

FIG. 3 Is a partially exploded back perspective view of the present invention illustrating how the invention is attached to the handle of a retractable leash device.

FIG. 4 Is an alternate side view of the present invention. Illustrating the method for which the soiled waste bag is held with the external clip.

FIG. 5 Is the section view to illustrate the direction the bag roll is unrolled and fed through the external clip and the direction the user is to pull the bag to tear the single waste bag from the roll.

FIG. 6 Is a back view of the body of the present invention illustrating the viewing.

FIG. 7 Is a bottom view of the body of the present invention illustrating the slot through the threads of the first compartment.

FIG. 8 Is a perspective view of the rubber cap removed from the invention with the attached plastic cover.

FIG. 9 Is a section view to illustrate the opening of the central compartment for storage of pet training treats.

FIG. 10 Is a perspective view of an alternate form of the present invention wherein the invention is attached to the handle of a fixed length traditional style leash.

FIG. 11 Is a cross section view of the clamping portion of the second form of the present invention in a closed state,

### DETAILED DESCRIPTION OF THE INVENTION

The inventor provides a unique pet walking organisational device, the present invention allows a user to conveniently dispense and store waste bags and training treats while walking their pet. The present invention is described in enabling detail in the following examples, which may represent more than one embodiment of the present invention.

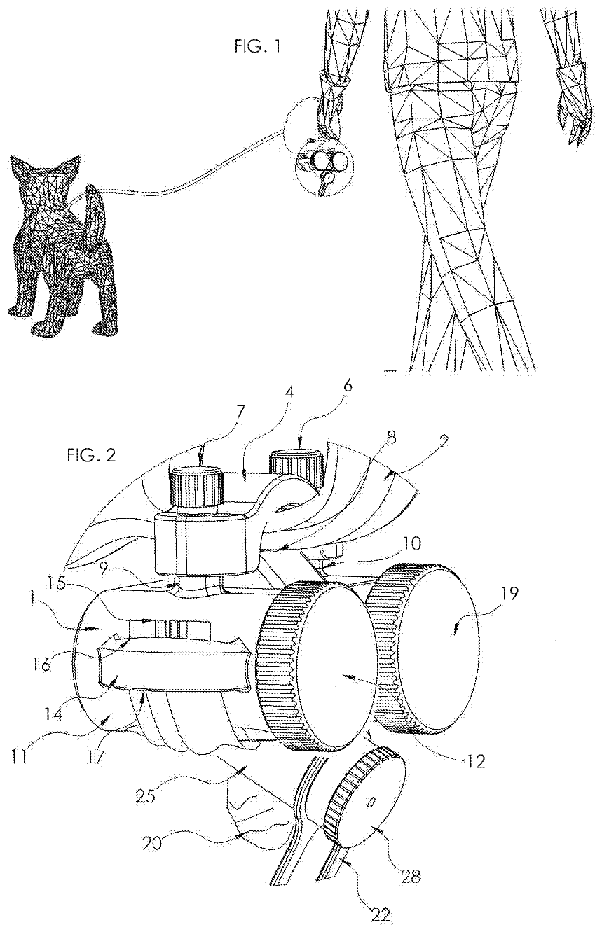

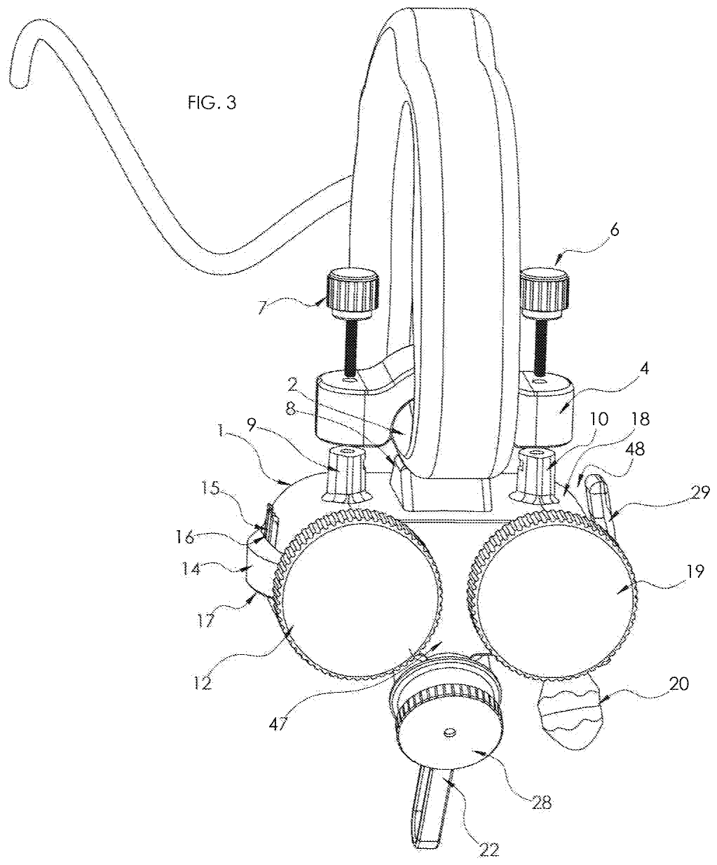

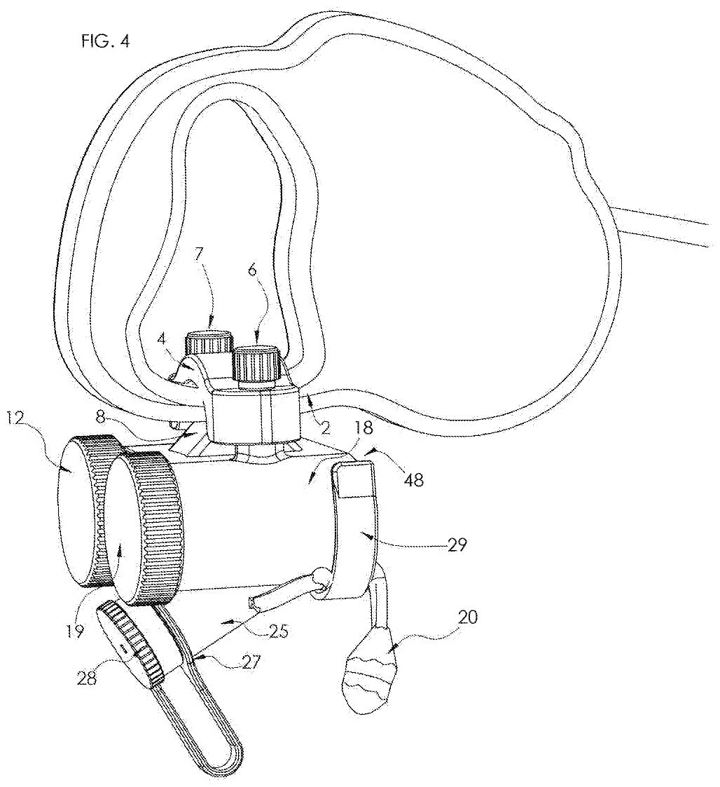

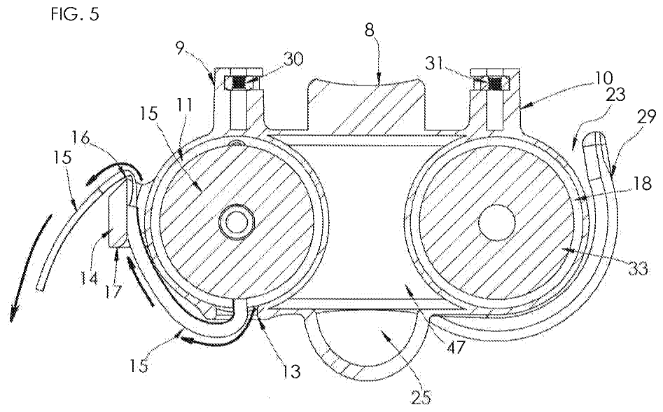

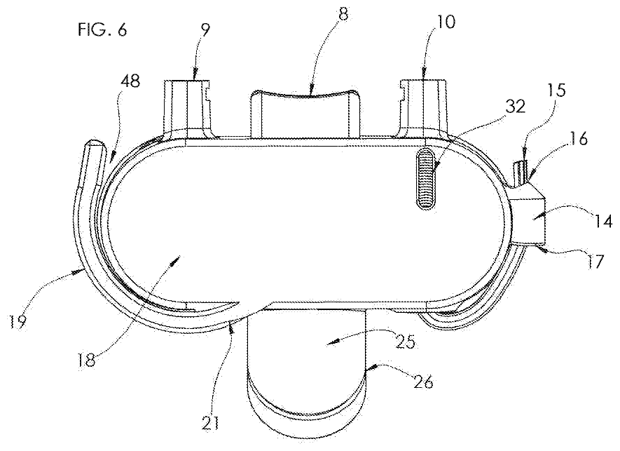

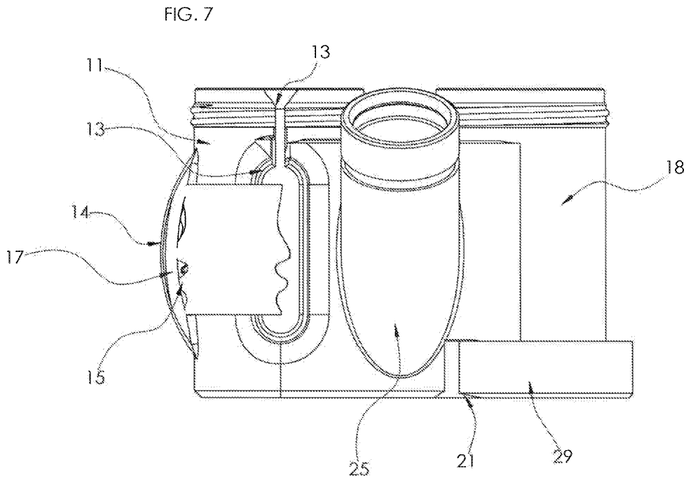

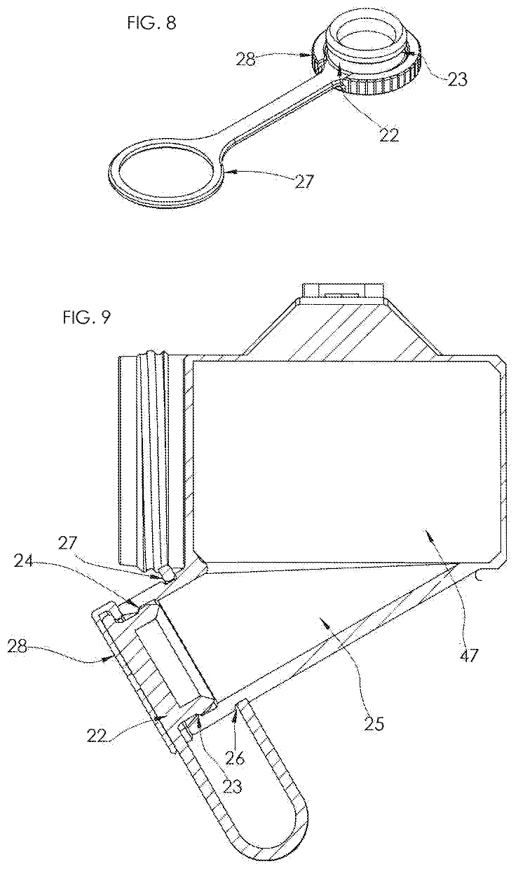

Referring to the drawings. FIG. 1 Is an illustrative view of the preferred embodiment of the invention in use. Shown is the user walking their dog with a retractable leash with an embodiment of the present invention.

FIG. 2 Is an enlarged view of the present invention in FIG. 1 as it is attached to the retractable leash. The body 1 of the present invention in this example is rigidly attached with an arched clamp 4 across the inside of the base of the handle 2 of a retractable leash being secured with two thumb screws 6 7 to the receptacle columns 9 10 on the body 1 of the device, the body 1 of the device has an arched support 8 to accommodate the underside of the retractable leash and two bilateral receptacle columns 9 10 which contain internal threads 30 31 to receive the thumb screws and allows for a rigid connection between the invention and varying sizes of retractable leashes without the use of additional tools.

In one embodiment of the present invention contains a first cylindrical compartment 11 parallel to the bottom of the handle of the retractable leash 2 enclosed with a threaded cap 12, distal to the clamp the compartment has a slot 13 through the threads that widens and is reinforced. This slot allows for the user to easily install the active waste bag roll end 15 through the slot to the exterior of the device.

In one embodiment of the present invention 90 degrees from the said slot is an arched clip 14 with a open end 17 facing towards the slot to allow the end of the active waste bag roll 15 to feed though easily but narrows to keep the bag tight to the side of the cylinder for storage, the opposite side of the clip faces towards the user and has a semi-sharp edge 16 which allows the user to grip the end of the bag roll and pull down and away from the device against the edge 16 of the clip 14 to allow the bag, to tear from the roll without taking the other hand off the leash. This motion creates the new end of the bag roll at the same spot for easy access for the next use.

In one embodiment of the present invention the posterior of this cylinder contains a slot 32 the length of which is perpendicular to the roll of waste bags, this allows the user to monitor the quantity of bags remaining on the active roll without opening the device.

In one embodiment of the present invention contains a second cylindrical compartment 18 parallel to the first cylindrical compartment and handle of the retractable leash enclosed with a threaded cap 19 meant for the user to store the spare standard size roll of waste bags 33.

In one embodiment of the present invention includes an open-ended clip 29 mounted to the outer surface at the base of the spare waste bag compartment 18. The clip is anchored from the bottom 21 of the invention and follows the curve of the rounded spare waste bag compartment 18 leaving enough space between the outside of the compartment and the clip for the narrow neck of a knotted used waste bag 20, opening 23 at the anterior of the device. This allows the user easy access to secure one or more knotted used waste bags aided by gravity in the clip with minimal effort. This also allows the user to remove the knotted used waste bags with minimal effort once the user is at the proper refuse disposal site.

In one embodiment of the present invention contains a third compartment 47 created by joining the two cylindrical waste bag compartments with four walls. This compartment has a tubular opening 25 angled towards the front bottom of the invention when attached to a retractable leash, the tubular is sized and shaped to allow training treats to pour out of the device when tilted. A circular rubber cap 22 is pressure fitted into the opening and held in place by a ridge 23 on the outer circumference of the cap and a corresponding tapered ridge 24 on the internal circumference of the tubular allowing for easy access to training treats. The exterior of the tubular has a ridge 26 to allow the opposing side 27 of the rubber cap to fit around to keep the cap 22 tethered to the invention during operation. The top of the rubber cap is fitted into a plastic shell 28 to increase rigidity of operation during removal and installation.

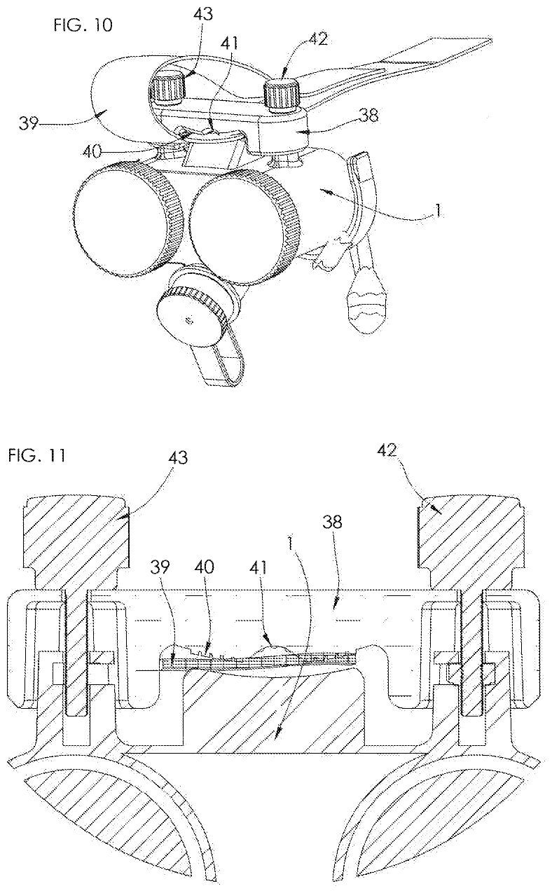

Referring now to FIGS. 10 and 11 In one embodiment of the present invention an alternate form of the invention is illustrated wherein the arched clamp is replaced with an inverted arched clamp 38 to allow attachment to a traditional style of dog leash 39 with two thumb screws 6 7 bilaterally attached to the body of the device 1. Additionally, this attachment has an arch 41 at the center of the inverted arch 40 to allow for clamping to a circular fixed length leash as with a rope style leash.

It will be apparent to one with skill in the art that the pet walking organizational device of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

1. A pet waste bag storage system comprising:
a cylindrical housing formed with an interior compartment including a bag roll containment chamber;
a securement means for detachable rigid securement to an existing extendable or permanent length pet leash wherein it contains a clamp assembly comprising a bracket positioned perpendicular to the longitudinal axis above the base of the handle with the body of the device positioned below the base of the handle and securing to the said handle by means of fastening from said bracket to receptacle columns on said body;
a clip mechanism attached to the outer surface of the device, said clip is configured along the longitudinal axis of the device and is bowed away from said outer surface and is disposed on either end of the clip to the outer surface to create a passageway for means of securing of the waste bag end;
a clip mechanism for semi-permanent securing of the pet waste bag is disposed to the outer surface of the said cylindrical body, said clip originates at the base of the cylindrical housing and runs parallel to said body directed along the circumference of said cylindrical body, said clip has a gap between the clip and the body of the device, said gap expands towards the open end of the said clip creating a wedge for semi-permanent securing of a knotted bag.

2. The device as described in claim 1 wherein the clamp assembly contains a plurality of screws of increased length to correspond with an increased height to the corresponding receptacle columns on the body allowing for attachment to a variety of thickness of leashes.

3. The device as described in claim 1 wherein the clip mechanism for securing the end of a waste bag contains an inlet to said passageway, the said inlet has a larger diameter then the exit creating a constriction of the passageway to assist in securement of the waste bag end, the exit of the passageway of the said clip contains an edge which combined with the added resistance of the constricted passageway allows for the tearing of a perforated separator of a standard roll of disposable bags.

4. The device as described in claim 1, wherein the cylindrical body contains a tubular compartment for dispensing waste bags, said compartment is aligned along the longitudinal axis of the pet leash and an open end directed towards the user.

5. The device as described in claim 4 wherein the said first tubular compartment contains an open-ended slot along the longitudinal axis of the said tubular whereas the said slot is open at the top of the said tubular. The said slot is open when the lid is removed and is closed with the lid reinstalled.
